(19) United States
(12) Patent Application Publication
(10) Pub. No.: US 2003/0157000 A1
(43) Pub. Date: Aug. 21, 2003

(54) Fluidized bed activated by excimer plasma and materials produced therefrom

(75) Inventors: Robert Allen Janssen, Alpharetta, GA (US); Jason Lye, Atlanta, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/365,315

(22) Filed: Feb. 12, 2003

Related U.S. Application Data
(60) Provisional application No. 60/357,326, filed on Feb. 15, 2002.

(51) Int. Cl. B32B 5/02

(52) U.S. Cl. 422/139; 422/186.05

(57) ABSTRACT

A housing for holding a fluidized bed activated by excimer plasma, includes a fluidization chamber for holding particles and gas. The fluidization chamber includes a central interior electrode contained within, having a conductive layer and a dielectric layer. The fluidization chamber further consists of at least one containment wall made from a dielectric material. The containment wall has an inside and an outside surface. An outer electrode is wrapped around the outside of the containment wall. A feed line is in fluid communication with the fluidization chamber for feeding plasma gas into the chamber, via a porous base. A radio frequency high voltage source is in electrical connection with both the inside/interior and outside electrodes.

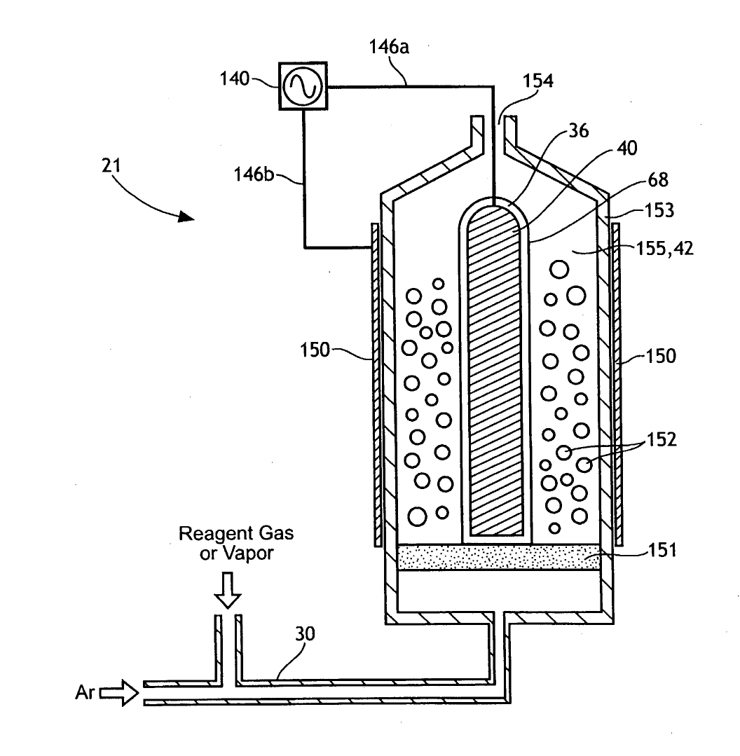

### TECHNICAL FIELD

This application claims priority from U.S. Provisional Application No. 60/357,326 filed on Feb. 15, 2002, which is incorporated by reference herein in its entirety.

The present invention relates to fluidized beds for treating beads and/or particles contained in such beds, methods of utilizing such fluidized beds to treat beads or particles contained therein, and the particles treated thereby.

### BACKGROUND

The use per se of fluidized beds in various industries is known. Additionally there have been instances described in the literature for methods of treating particles by layering polymeric coatings over the surface of particles via use of a mechanical perturbational (stirring) device to circulate particles while a gas stream is allowed to pass through an RF coil, around the mechanical device, and through the particles. See for instance, Uniform Deposition of Ultrathin Polymer Films on the Surfaces of Al₂O₃ Nanoparticles by a Plasma Treatment, Department of Materials Science and Engineering, University of Cincinnati, Ohio 45221-0012, Dept. of Nuclear Engineering and Radiological Science, University of Michigan, June, 2000. However, such methodology does not insure that a uniform exposure of gas to all surfaces of the nanoparticles occurs or that a uniform coating of polymeric material is applied to all of the particle surfaces, or even that certain particle agglomerates will not accumulate in and around a mechanical stirring apparatus. Therefore, there is a need in the art for a uniform surface treatment of particles for a variety of end uses, including for printing applications and the like, but with reduced risk of particle agglomeration via such treatment methods.

### SUMMARY OF THE INVENTION

An apparatus for holding a fluidized bed activated by excimer plasma includes a fluidization chamber for holding beads and/or particles and gas. The fluidization chamber includes a central electrode contained within or inside the chamber, having a conductive layer and a dielectric layer. The fluidization chamber further includes at least one containment wall made from a dielectric material. The containment wall has an inside and an outside surface. An outer electrode is wrapped around the outside surface of the containment wall. A feed line is in fluid communication with the fluidization chamber for feeding plasma gas into the chamber, and the chamber wall(s) further define(s) an exit to allow fluid (gas) contained within, or introduced into the chamber, to exit. The housing further includes a porous material situated between the feed line and the fluidization chamber, through which the fluid passes from the feed line into the fluidization chamber. A radio frequency high voltage source is in electrical connection with both the inside and outside electrodes for inducing ionization of the gas. The chamber relies on the movement of fluid within the structure to maintain the beads or particles separated, and for the uniform modification of particle surfaces contained in the chamber.

In one specific embodiment, an apparatus for holding a fluidized bed activated by excimer plasma includes a fluidization chamber for holding polymeric beads or inorganic particles and gas. The fluidization chamber includes an interior/inside electrode contained within, having a conductive layer and a dielectric layer. The fluidization chamber has at least one containment wall made from a dielectric material, with the containment wall having an inside and an outside surface. An outer electrode is wrapped around or surrounds the outside surface of the at least one containment wall. A feed line is in fluid communication with the fluidization chamber. The feed line is for feeding plasma gas and reagents into the chamber. A porous base is in fluid communication with the feed line, through which plasma gas (and reagents) pass from the feed line before entering the chamber. The porous base has pores of a diameter less than the diameter of beads or particles to be contained within the housing. The apparatus also includes a fluid exit in the at least one containment wall. A radio frequency high voltage source is in electrical connection with both the inside and outside electrodes for inducing ionization of the gas.

In still another specific embodiment, the porous base is comprised of either a porous glass frit or a polymeric membrane. In still another specific embodiment the porous base includes pores having diameters of between about 0.001 microns and 4 millimeters. In still another specific embodiment the interior electrode comprises a conductive layer of aluminum, silver or gold. In still another specific embodiment the outer electrode includes a conductive material selected from either metal foil, metal gauze or a metallic coating. In still another specific embodiment the inside/ interior electrode further includes a central cooling tube.

A method for modifying the surface properties of polymeric beads or inorganic particles includes the steps a) providing polymeric beads or inorganic particles to be modified, b) placing/containing the polymeric beads or inorganic particles in a bed to be fluidized, and c) fluidizing the beads or particles within the bed using ionized gas plasma containing excimers. In another specific embodiment of the method, the gas plasma containing excimers is generated at atmospheric pressure. In still another specific embodiment of the method, the gas plasma containing excimers is generated at less than atmospheric pressure. In still another specific embodiment of the method, the gas plasma containing excimers is generated between about 760 mm Hg to about 0.1 mm Hg. In still another specific embodiment of the method, the gas plasma containing excimers is generated between about 760 mm Hg to about 380 mm Hg. In still another specific embodiment of the method, the method further includes the step of introducing a reagent into the bed with the gas plasma containing excimers. In still another specific embodiment of the method, the step of fluidizing the beads or particles is accomplished through a porous base structure.

In still another specific embodiment of the method, the gas plasma containing excimers is generated by passing an inert gas between two electrodes. In still another specific embodiment of the method, the beads or particles are between about 0.01 micron and 5 millimeter in diameter. In still another specific embodiment of the method, the beads are selected from the group of materials consisting of polystyrene, polyolefins such as polyethylene and polypropylene, polyurethanes, polyvinyl acetates, polyvinyl alcohols, polyesters such as polyethylene terephthalate, nylon such as nylon 6 and nylon 6,6, poly(vinylpyrrolidone), poly(vinylfluoride), silicones, poly(vinylchloride), poly(methylmethacrylate), poly(methacrylate), and copolymers such as poly(styrene butadiene). In still another specific embodiment of the method, the particles are selected from the group of materials consisting of silicon dioxide, titanium dioxide, alumina, alumina coated silica, carbon nanotubes, ceramics, glass beads, iron oxide, zinc oxide, magnesium oxide, zeolites, alumina silicates, boron oxide, silicon nitride, PZT piezoelectric ceramics, silicon oxynitride, and tantalum pentoxide. In still another specific embodiment of the method, the excimer plasma fluidizes the beads or particles at a velocity between about 2.2×10⁻⁸ and 9.2×10⁻⁷ cm/sec. In still another specific embodiment of the method, the excimer plasma fluidizes the beads or particles at a velocity between about 1.1×10⁻⁷ and 4.6×10⁻⁶ cm/sec. In still another specific embodiment of the method, the excimer plasma fluidizes the beads or particles at a velocity between about 2.2×10⁻⁷ and 9.2×10⁻⁶ cm/sec. In still another specific embodiment of the method, the reagent is selected from the group consisting of aliphatic compounds, acrylates, methacrylates, alcohols, acrylate and methacrylate esters of fluorocarbons, epoxidized acrylates, silicone compounds, silanes, water, sulfur oxides, nitrogen oxides, ammonia, amines, chlorinated compounds, carboxylic acids, fluorinated compounds, perflourinated compounds, hydrogen and oxygen.

Finally the invention also includes polymeric beads or inorganic particles with surfaces modified by the previously described methods.

### BRIEF DESCRIPTION OF THE FIGURE

The Figure illustrates a cross-sectional view of a fluidized bed excimer plasma treatment system in accordance with the invention, wherein argon gas is used to fluidize materials being treated, as well as to form the excimer treatment plasma. Reagents are optionally introduced into the argon gas stream.

### DETAILED DESCRIPTION OF THE INVENTION

A variety of particulate materials can be treated with an excimer plasma and thereby be provided with improved material properties, without the necessity for low pressure or vacuum conditions. For the purposes of this application, the term “excimer” shall refer to plasma produced by ionizing a gas so that excimer states are produced. When the entities forming the excimer dissociate, a photon is emitted as the entities return to their ground state (excimer emission). In the case of an argon excimer, excited argon atoms or ions associate to form a diatomic excimer excited state. Excimer emission in excimer lamps or excimer producing devices, is typically induced using a radiofrequency power supply (e.g., a microwave source or a radiofrequency source) which generates a plasma (an ionized gas in which the number of free electrons is approximately equal to the number of positive ions) within a “lamp” having an output window of a material such as quartz. In the plasma, which is typically at low pressure (e.g., less than 2 torr), but which may be at atmospheric pressure, excimers repeatedly form and then dissociate, yielding high-energy photons, including those in the vacuum ultra-violet range (VUV). Excimer radiation can generate free radicals and be used to modify a surface. Alternatively, excited ions and atoms may collide with the surfaces of substrates, inducing events such as chain scission, or ionization, thereby activating the surface toward further chemical reaction. Since plasma (and thus excimer radiation) has the potential to be produced with high energy efficiency and the potential to produce photons in an energy range useful for driving numerous chemical reactions without causing significant structural damage to a polymeric or inorganic particulate substrate, a plasma-based treatment system such as an excimer fluidized bed for surface modification, could assist in modifying commercial quantities of such polymers or particulates. Such a bed can lead to increased hydrophobicity for improved water and alcohol repellency, or for the addition (e.g., grafting) of other useful functionalities, such as for example, hydrophilicity, biocompatibility, or thromboresistance.

In particular, an excimer plasma system can generate a plasma at atmospheric pressure. In an alternative embodiment, an excimer plasma system can generate a plasma at low pressure. For instance, a plasma can be generated between about 760 mm Hg (Atmospheric pressure) to 0.1 mm Hg. In a further alternate embodiment, a plasma can be generated between about 760 mm Hg to 380 mm Hg. Since it operates at such pressures, this plasma can be used to activate a fluidized bed which is composed of beads, and in particular, polymeric beads, or alternatively inorganic particles (such as spherical particles), without much effort. For the purposes of this case, the term “particles” shall be used interchangeably with “particulates”. The plasma gas would not only cause the bed to become fluidized, but would simultaneously initiate a surface conversion on the polymeric beads or inorganic particles for a specific application. Such applications might include biomaterials use, colored beads to adhere to a substrate for digital imaging purposes, and the like. Such beads or particles could essentially deliver a functionality to a given receiver substrate.

As previously described, such an excimer plasma system generates a plasma through the ionization of a particular gas. Such gas may be for example, selected from the group of inert gases including helium, neon, argon, krypton and xenon. A reagent gas may also be included in the system, e.g. oxygen or CF₄, available from Aldrich. This process may take place at atmospheric pressure and subsequently vent to atmospheric conditions. As a result, the gas can be used to initiate fluidization in a column of beads. That is, the flow of the plasma gas through the particle bed can be adjusted so that it will fluidize. Alternatively, a vacuum pump (not shown) could be attached to the system (such as at 154 of the Figure) to reduce pressure within the chamber. In either instance, the bed of beads or particles will be activated and subsequently, a reagent may be passed through the bed, such as to deposit a polymeric coating on the particles.

One advantage of being able to accomplish this true fluidization with such a system (as opposed to use of a mechanical perturbational device) is that every bead or particle will be completely exposed to the plasma gas as the beads/particles float (are in fluid motion) within the fluid. Subsequently, the plasma will be able to impart a specific surface modification to the polymeric beads or inorganic particles in a uniform manner. The nature of the plasma gas and conditions will dictate the surface conversion that will be imparted to the polymeric beads or inorganic particles. Examples of such functionality could be to make the beads hydrophilic or hydrophobic, or to impart a specific charge to the particle for adherence of other organic groups such as dyes or thromboresistance agents. Additional functionality may also allow the particles to bind to textiles, fabrics or paper substrates. This binding could take place via a covalent bond or ionic interaction.

For the purposes of this application, the types of polymeric beads and particles that may be modified in the fluidized bed may vary greatly. For example, such polymeric beads may include but be not limited to polystyrene, polyolefins such as polyethylene and polypropylene, polyurethanes, polyvinyl acetates, polyvinyl alcohols, polyesters such as polyethylene terephthalate, nylon such as nylon 6 and nylon 6,6, poly(vinylpyrrolidone), poly(vinylfluoride), silicones, poly(vinylchloride), poly(methylmethacrylate), poly(methacrylate), and copolymers such as poly(styrene butadiene). Such inorganic particles may include, but be not limited to silicon dioxide (silica available in various grades such as Fumed Silica Aerosil® from Degussa, South Plainfield, N.J.), titanium dioxide, (available from Whittaker, Clark & Daniels, Inc, also of South Plainfield, N.J.), alumina, alumina coated silica, carbon nanotubes, ceramics, glass beads (available from Superior Micropowders, Alberquerque, N.M.), iron oxide, zinc oxide, magnesium oxide, zeolites, alumina silicates, boron oxide, silicon nitride, PZT piezoelectric ceramics, silicon oxynitride, and tantalum pentoxide.

The Figure depicts a cross sectional view of a fluidized bed plasma treatment system in accordance with the present invention. The system (apparatus), 21 uses an excimer plasma to activate particle surfaces, while the gas used to generate the plasma simultaneously fluidizes particles or beads 152. Since the plasma can be generated at atmospheric pressures, the plasma gas (argon for example) will flow, via feed line 30, into the fluidization chamber 155 (broadly a housing). The gas flows through a porous base, 151, which disperses the gas into the polymeric particles to give an essentially uniform cross-directional pressure distribution beneath the particles 152 contained in the fluidization chamber 155. The porous base may be for instance manufactured from a porous material such as for example a porous glass (frit) or polymeric membrane, and should be sufficiently porous to allow for the passage of the gas. However such porous material should also be a sufficient barrier to stop the passage of the particles or beads contained in the bed (particle size limiting) into the feed line. Desirably the porous base has pores in the range of about 0.001 microns to 4 millimeters in diameter size.

Particle or bead sizes that may be treated using this system range from about 0.01 microns in diameter to about 5 millimeters in diameter, however other sizes of particles or beads could be treated, depending upon their density and the gas flow rate used for the fluidization process. In an alternative embodiment, such particle/bead sizes may range from between about 0.03 microns in diameter to about 5 millimeters. The shapes of the particular particles may vary, but in a desired embodiment, the particles are spherical in their configuration.

A reagent gas, to impart a specific surface modification to the particles, may be optionally introduced into the argon stream by means of feed line 30. Examples of such reagents include such materials as aliphatic compounds, acrylates, methacrylates, alcohols, acrylate and methacrylate esters of fluorocarbons, epoxidized acrylates, silicone compounds, silanes, water, sulfur oxides, nitrogen oxides, ammonia, amines, chlorinated compounds, carboxylic acids, fluorinated compounds, perflourinated compounds, hydrogen and oxygen. Such reagents may be used to impart surface coatings or other desirable attributes to the particles/beads, such as to make them more receptive to other materials. Such gas/reagents exits the fluidization chamber via exhaust outlet 154.

Within the fluidization chamber 155 is a cylindrical interior electrode 68 comprising a conductive layer 40 (such as a metallic layer of aluminum, silver or gold) and a dielectric layer 36, such as quartz or glass. The interior electrode may be centrally situated within the chamber. The walls of the fluidization chamber 155 consist of a containment wall made from a dielectric material 153, such as quartz or glass. The containment wall(s) of the fluidization chamber is desirably a continuous single wall with rounded edges defining the chamber to allow for uninterrupted fluid flow. In an alternative embodiment, the containment wall is actually multiple planar walls coming together at corners. A concentric outer electrode 150 is wrapped around/surrounds the outside of the containment wall(s) 153, and could be, for instance, a metal foil, or metal gauze, or a conductive coating as previously described. The electrodes are connected to a high voltage radio frequency source 140 via wiring 146a and 146b. Voltages applied may be from 0.5 to 25 kV, more specifically, from about 1 to 10 kV, with frequencies below 10 MHz, more specifically from about 1 to about 2 MHz. Optionally, the central electrode 68 may be cooled by the flow of water or other cooling fluid (e.g. compressed air) through a central cooling tube (not shown) typically made from a non-conducting material such as glass or quartz. The length of the bed will vary by the use application (such as whether the application is a laboratory experiment or commercial production) and it is submitted that the appropriate length of the fluidized bed desired will be easily determined by those skilled in the art of fluidized beds.

A radio frequency high voltage applied across the two electrodes 68 and 150 can lead to a dielectric barrier discharge in the excimer plasma generation zone 42. If the gas flow through the fluidization chamber 155 is sufficient to cause fluidization of particles 152, excimer plasma generation and subsequent surface activation of the fluidized particles will take place, leading to uniform surface treatment of particles.

As the flow of a gas through a bed of particles increases, it will eventually reach a condition where the particles are in “fluid” motion. This occurs when the pressure drop of the gas flowing through the bed equals the gravitational forces of the particles. The onset of this condition is called minimum fluidization.

The Carmen-Kozeny equation correlates the various parameters of the particles and the processing parameters with the pressure drop through the bed. It is summarized by equation (1).

$$\frac{( - Δ P ) \cdot g}{L} = \frac{{( 1 - ϵ )}^{2} \cdot μ \cdot v \cdot k}{{ϵ}^{3} \cdot {D}^{2}} \qquad ( 1 )$$

Where:

ΔP=The pressure drop of the gas through the bed.

g=Gravitational constant.

L=The length of the bed.

ε=The void volume of the bed.

μ=The viscosity of the gas.

v=The superficial velocity of the gas through the bed.

D=The diameter of the particle spheres.

k=A constant.

The minimum velocity, vₘ, for fluidization to occur can be obtained from equation (1) by writing a force balance around the bed with the length of L and letting this equal the pressure drop through the bed. When this is completed, and certain assumptions are made on the magnitude of terms, equation (2) is generated.

$${v}_{m} = ( \frac{{ϵ}^{3}}{1 - ϵ} ) \cdot \frac{( {ρ}_{S} - ρ ) \cdot g \cdot {D}^{2}}{150 \cdot μ} \qquad ( 2 )$$

Where:

ρ=The density of the gas.

ρₛ=The density of the particle spheres.

The vₘ term in equation (2) is the minimum velocity for the bed to become fluidized and it relates back to the parameter of the beads and fluidizing gas and void volume of the bed.

Beyond this velocity the particles will exhibit flow characteristics of ordinary fluids.

Particle sizes typically range from 20 to 500 microns in diameter that are used in heated (non plasma) fluidized beds for cracking catalysts in the petroleum industry. However, a broad spectrum of diameters can be used depending on their density as previously described.

Utilizing equation (2), the minimum gas velocity for bed fluidization was calculated for particles which were spherical in shape. This was done for particle densities of 1.0, 5.0 and 10.0 grams/cm³. A nominal particle diameter of 20 nanometers was used as the basis for comparison. These variable values are desirable for particles to be used in printing processes, and in particular ink jet printing processes, where small sized particles are sought so as to avoid clogging of print heads.

Also, in order to calculate the plasma gas density in the bed, an operating pressure of 10 mm of mercury was used as the basis. However, this is not a significant parameter in equation (2) because the density of the particles will exceed the gas density by several orders of magnitude. Since it is the difference in these two densities that is used in equation (2), the particle density will dominate.

The cgs unit system was used in the equation. That is, the units are in centimeters, grams and seconds. Listed below are the parameters with the appropriate units.

Density (ρ) (=) grams/cm³

Gravitational Constant (g) (=) 981 cm/sec²

Particle Diameter (Dₚ) (=) cm

Viscosity (μ) (=) grams/cm. sec.

The constant (k) is dimensionless and has a value of 150.

Void Volume, ε, is the fractional volume of the bed that is completely void. A void volume of 0.45 means that 45 percent of the bed volume is empty and that 55 percent is solid. A void volume of 0.90 means that the entire bed is 90 percent empty.

To start the bed to fluidize, it will initially represent a loose packing of spheres. The void volume for this type of bed is typically 0.45. This is the value substituted into equation (2) to calculate the minimum gas velocity for bed fluidization.

However, there is also a maximum gas velocity that this bed can sustain prior to disintegration, that is, prior to the particles flowing out the exit of the bed and being carried away by the fluid. This value was determined by calculating the gas velocity term for a bed that has expanded to a void volume of 0.90. This would represent the onset of physically “blowing” the bed away.

Based upon the kinetic theory of gases, there is a lack of dependence of the viscosity on pressure at low pressures. Therefore, the viscosity of a standard gas at standard pressure will be used. The gas viscosity parameter in equation (2) was set equal to 0.0002 poise.

The following Table 1 summarizes the results for the minimum gas velocity that will initiate fluidization of a bed to the maximum velocity that will result in disintegration, for particles which are desirably used with the inventive system. These calculations were performed on spherical particles which had a diameter of 20 nanometers and at three different densities.

TABLE 1

| | Particle Density | Particle Density | Particle Density |
|---|---|---|---|
| Gas Velocity | 1.0 gram/cm³ | 5.0 gram/cm³ | 10.0 gram/cm³ |
| Minimum | 2.2 × 10⁻⁸ | 1.1 × 10⁻⁷ | 2.2 × 10⁻⁷ |
| (cm/sec) | | | |
| Maximum | 9.2 × 10⁻⁷ | 4.6 × 10⁻⁶ | 9.2 × 10⁻⁶ |
| (cm/sec) | | | |

The excimer plasma fluidized bed technique can also be used to produce hydroperoxides on the surface of polymeric beads/particles. These moieties can then be used for subsequent break down for the graft polymerization of specific groups on the beads/particles.

In an alternate embodiment of the fluidized bed methodology, the generation of free radicals on the surface of the polymeric beads through the interaction of the argon plasma may be accomplished. At the conclusion of this free radical- generating phase, a gas would be pumped through the particle bed, which would react with these free radicals and also fluidize the particles. An example would be an acrylate or methacrylate group which could undergo free radical polymerization onto the surface of the beads.

The objective carrying out a surface modification on polymeric beads and inorganic particles would be for the attachment of groups for specific applications. For example, polystyrene beads could be subjected to the argon plasma with the objective of being able to attach enzymes to the surface of these beads. This could be accomplished by activating the polystyrene beads with the argon plasma and then allowing the attachment of, for example purposes, acrylic acid. These carboxyl acid groups would subsequently allow for the chemical covalent bonding of an enzyme on the surface of the beads. These beads could then be used for enzymatically catalyzed reactions. Alternatively, the carboxyl group could be used to attach a quaternary amine onto the surface of the beads, for instance by esterification of surface carboxyl groups with for instance choline.

The objective for carrying out a surface modification on inorganic particles would also be for the attachment of groups for specific applications. For example, titanium dioxide particles could be subjected to the argon plasma with the objective of being able to initiate polymerization onto the surface of the particles. This could be accomplished by activating the titanium dioxide with the argon plasma and then allowing the attachment of, for example purposes, acrylic acid, which may be introduced as a vapor. The carboxyl acid groups would subsequently allow for the chemical covalent bonding of an enzyme or dye on the surface of the particles. These particles could then be used for enzymatically catalyzed reactions, or to color textiles. Alternatively, the carboxyl group could be used to attach quaternary amine groups onto the surface of the particles, for instance by esterification of surface carboxyl groups with for instance choline.

Other examples of reagents may include the use of water or ammonia to generate hydroxyl or amino groups respectively on the surface of polymeric particles. Such groups could be further reacted with for example a chlorotriazine, or a bis-vinyl sulfone, or a bis-sulfatoethylsulfone, thus allowing enzymes to be immobilized onto the surface of the particles. Furthermore, entire cells, for instance, mammalian cells, yeast cells, bacteria cells, could be attached to the surface of polymeric substrates using for instance a bis-vinylsulfone group to link the cell to the functionalized bead or polymeric particle.

In an alternative embodiment, the embodiment of the fluidized bed that has been described could be one that generates plasma using a capacitive discharge through the dielectric wall as part of a tuned LCR circuit. In an alternative embodiment of this fluidized bed, the bed may include a coil wrapped around the fluidized bed to inductively generate plasma, the capacitor forming the remainder of the LCR circuit would be contained in the power supply, and could be tuned to provide resonance.

While the invention has been described in detail with particular reference to a preferred embodiment thereof, it should be understood that many modifications, additions, and deletions can be made thereto without departure from the spirit and the scope of the invention as set forth in the following claims.

We claim:

1. An apparatus for holding a fluidized bed activated by excimer plasma, said housing comprising:
a fluidization chamber for holding polymeric beads or inorganic particles and gas, said fluidization chamber including an interior electrode contained within, comprising a conductive layer and a dielectric layer, and further, said fluidization chamber comprising at least one containment wall made from a dielectric material, said containment wall having an inside and an outside surface,
an outer electrode surrounds at least part of the outside surface of the containment wall,
a feed line in fluid communication with said fluidization chamber, said feed line for feeding plasma gas and/or reagents into said chamber,
a porous base in fluid communication with said feed line, through which plasma gas passes from said feed line before entering said chamber, said porous base having pores of a diameter less than the diameter of beads or particles to be contained within the housing,
a fluid exit in said at least one containment wall, and
a radio frequency high voltage source, in electrical connection with both the interior and outside electrodes, for inducing ionization of the gas.

2. The housing of claim 1, wherein said porous base is comprised of either a porous glass frit or a polymeric membrane.

3. The housing of claim 1, wherein said porous base includes pores having diameters of between about 0.001 microns and 4 millimeters.

4. The housing of claim 1, wherein said central electrode comprises a conductive layer of aluminum, silver or gold.

5. The housing of claim 1, wherein said outer electrode includes a conductive material selected from either metal foil, metal gauze or a metallic coating.

6. The housing of claim 1 wherein said central electrode further includes a central cooling tube.

7. The housing of claim 1 wherein said outer electrode is a coil.

8. A method for modifying the surface properties of polymeric beads or inorganic particles, said method comprising:
a) providing polymeric beads or inorganic particles to be modified,
b) containing said polymeric beads or inorganic particles in a bed to be fluidized,
c) fluidizing the beads or particles within the bed using ionized gas plasma containing excimers.

9. The method of claim 8, wherein said gas plasma containing excimers is generated at atmospheric pressure.

10. The method of claim 8, wherein said gas plasma containing excimers is generated at less than atmospheric pressure.

11. The method of claim 8, wherein said gas plasma containing excimers is generated between about 760 mm Hg to about 0.1 mm Hg.

12. The method of claim 11, wherein said gas plasma containing excimers is generated between about 760 mm Hg to about 380 mm Hg.

13. The method of claim 8, further including the step of introducing a reagent into the bed with the gas plasma containing excimers.

14. The method of claim 8, wherein the step of fluidizing the beads or particles is accomplished through a porous base structure.

15. The method of claim 8, wherein the gas plasma containing excimers is generated by passing an inert gas between two electrodes.

16. The method of claim 8, wherein said beads or particles are between about 0.01 micron and 5 millimeter in diameter.

17. The method of claim 8 wherein said beads are selected from the group of materials consisting of polystyrene, polyolefins such as polyethylene and polypropylene, polyurethanes, polyvinyl acetates, polyvinyl alcohols, polyesters such as polyethylene terephthalate, nylon such as nylon 6 and nylon 6,6, poly(vinylpyrrolidone), poly(vinylfluoride), silicones, poly(vinylchloride), poly(methylmethacrylate), poly(methacrylate), and copolymers such as poly(styrene butadiene).

18. The method of claim 8 wherein said particles are selected from the group of materials consisting of silicon dioxide, titanium dioxide, alumina, alumina coated silica, carbon nanotubes, ceramics, glass beads, iron oxide, zinc oxide, magnesium oxide, zeolites, alumina silicates, boron oxide, silicon nitride, PZT piezoelectric ceramics, silicon oxynitride, and tantalum pentoxide.

19. The method of claim 8 wherein said excimer plasma fluidizes the beads or particles at a velocity between about 2.2×10⁻⁸ and 9.2×10⁻⁷ cm/sec.

20. The method of claim 8 wherein said excimer plasma fluidizes the beads or particles at a velocity between about 1.1×10⁻⁷ and 4.6×10⁻⁶ cm/sec.

21. The method of claim 8 wherein said excimer plasma fluidizes the beads or particles at a velocity between about 2.2×10⁻⁷ and 9.2×10⁻⁶ cm/sec.

22. The method of claim 13 wherein said reagent is selected from the group consisting of aliphatic compounds, acrylates, methacrylates, alcohols, acrylate and methacrylate esters of fluorocarbons, epoxidized acrylates, silicone compounds, silanes, water, sulfur oxides, nitrogen oxides, ammonia, amines, chlorinated compounds, carboxylic acids, fluorinated compounds, perflourinated compounds, hydrogen and oxygen.

23. Polymeric beads or inorganic particles with surfaces modified by the method of claim 8.
